(19) United States
(12) Patent Application Publication
(10) Pub. No.: US 2018/0126385 A1
(43) Pub. Date: May 10, 2018

(54) FOOT-OPERATED PAPER SHREDDER

(71) Applicant: Hua-Chang WU, New Taipei City (TW)

(72) Inventor: Hua-Chang WU, New Taipei City (TW)

(21) Appl. No.: 15/383,359

(22) Filed: Dec. 19, 2016

(30) Foreign Application Priority Data
Nov. 9, 2016 (TW) 105217082

(51) Int. Cl. B02C 18/00; B02C 18/24

(52) U.S. Cl. CPC B02C 18/0007; B02C 18/24

(57) ABSTRACT

A foot-operated paper shredder includes a housing, a driving mechanism mounted in the bottom of one side of the housing and including a base, a foot pedal mounted on the base and biasable up and down relative to the base and a composite gear mounted on the base and rotatable by the foot pedal, a spindle mounted on the base and rotatable by the composite gear, and a cutter module mounted in the top side of the housing and including a cutting shaft and a transmission gear fixedly connected to one end of the cutting shaft and drivable by the spindle to rotate the cutting shaft. Thus, the foot-operated paper shredder can be operated by foot, and allows replacement of a different cutter module to meet different shredding needs.

### BACKGROUND OF THE INVENTION

### 1. Field of the Invention

The present invention relates to paper shredder technology and more particularly, to a foot-operated paper shredder.

### 2. Description of the Related Art

Paper shredder is a common office machine used to cut paper documents or CDs into strips or little pieces. Because companies will produce a lot of obsolete confidential documents or CDs, in order to prevent confidential outflow, company staffs will need a paper shredder to cut abandoned files or CDs into strips or little pieces. When using a paper shredder, the user needs to put waste documents or CDs into the paper shredder, at this time, the internal mechanism of the paper shredder is driven by electricity to rotate cutters, thereby cutting the waste documents or CDs into strips or little pieces, so that these waste documents or disc strips or pieces will not be easily patched or reorganized, achieving the purpose of confidentiality.

However, commercial paper shredders are commonly of electric drive design. Therefore, commercial paper shredders commonly have motor, circuit board and other components mounted therein for operation. These paper shredders are expensive to manufacture, and their application is limited to specific occasions. In case of power outages or no nearby power outlet available, these paper shredders become not operable. Further, consuming electric power for operation is clearly not in keeping with the today's rising awareness of environmental protection.

Further, different designs of paper shredders may be needed for shredding different documents. For example, a cross-cut paper shredder may be needed for cutting high confidential documents into little pieces to avoid patching or reorganization of the cut pieces. Thus, users may need to purchase different designs of paper shredders to meet different shredding requirements, not only increasing the cost but also occupying much installation space and bringing inconvenience.

### SUMMARY OF THE INVENTION

The present invention has been accomplished under the circumstances in view. It is the main object of the present invention to provide a foot-operated paper shredder, which can be operated by foot, and allows replacement of a different cutter module to meet different shredding needs.

To achieve this and other objects of the present invention, a foot-operated paper shredder comprises a housing, a driving mechanism, a spindle and a cutter module. The driving mechanism is mounted in the bottom of one side of the housing, comprising a base, a foot pedal and a composite gear. The foot pedal is mounted on the base and biasable up and down relative to the base. The composite gear is mounted on the base, and rotatable by the foot pedal. The spindle is mounted on the base, and rotatable by the composite gear. The cutter module is mounted in the top side of the housing, comprising a cutting shaft and a transmission gear. The transmission gear is fixedly mounted at one end of the cutting shaft, and drivable by the spindle to rotate the cutting shaft.

Preferably, the cutter module is detachably mounted in the top side of the housing, Further, the cutting shaft can be a strip-cut cutting shaft or cross-cut cutting shaft.

Thus, the foot-operated paper shredder is operable by foot. When the user steps on the foot pedal, the composite gear, the spindle, the transmission gear and the cutting shaft are driven to rotate, thereby cutting waste paper into strips or little pieces. The foot-operated paper shredder is inexpensive to manufacture, and its application is not limited to specific occasions (such as power outages or no nearby power outlet available). Thus, the foot-operated paper shredder is in line with the current trend of environmental protection and energy conservation. Further, the user can conveniently replace a different design of cutter module according to different shredding requirement.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an oblique top elevational view of a foot-operated paper shredder in accordance with the present invention.

FIG. 2 is a sectional side view of the present invention, illustrating the arrangement of the components in the housing.

FIG. 3 is another sectional side view of the present invention, illustrating the cutter module taken out of the housing.

### DETAILED DESCRIPTION OF THE INVENTION

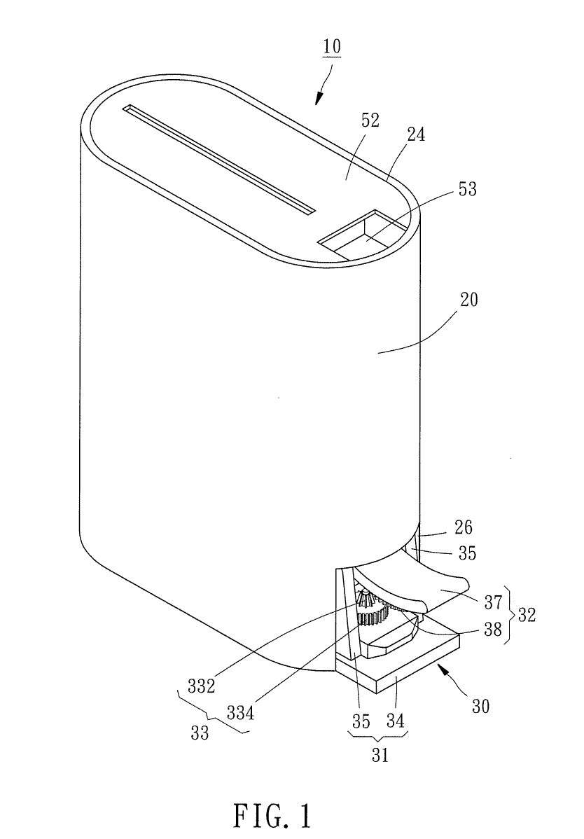

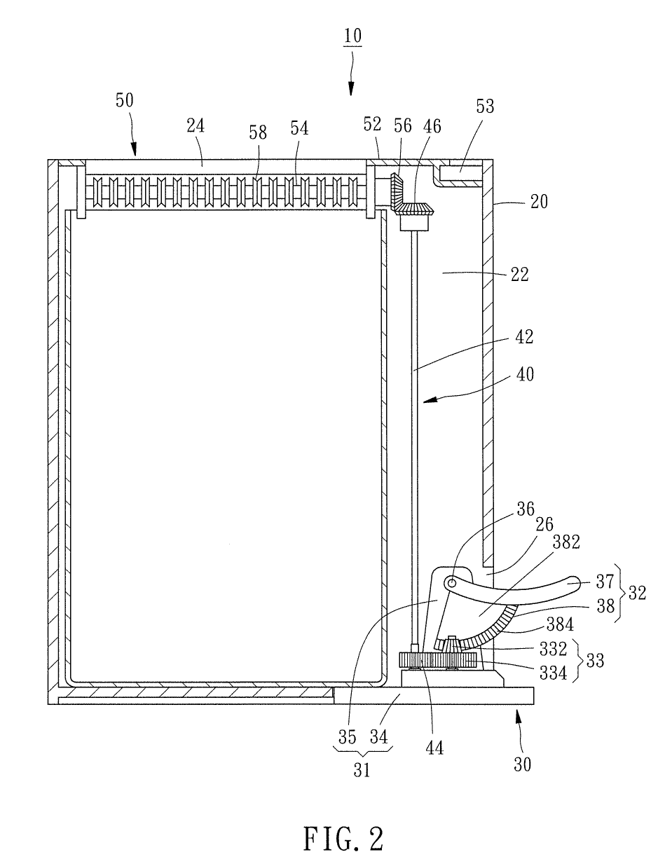

Referring to FIGS. 1 and 2, a foot-operated paper shredder 10 in accordance with the present invention is shown. The foot-operated paper shredder 10 comprises a housing 20, a driving mechanism 30, a spindle 40 and a cutter module 50.

The housing 20 is a hollow container, comprising an accommodation chamber 22, a top opening 24 and a side opening 26. The accommodation chamber 22 is defined inside the housing 20. The top opening 24 is located on a top side of the housing 20 and disposed in communication with the accommodation chamber 22. The side opening 26 is located on a bottom of one side of the housing 20 and disposed in communication with the accommodation chamber 22. In the present preferred embodiment, the accommodation chamber 22 accommodates a dustbin 28. The dustbin 28 is adapted for collecting shredded paper pieces or CD fragments.

The driving mechanism 30 is mounted in the housing 20 at a bottom side to face toward the side opening 26, comprising a base 31, a foot pedal 32 and a composite gear 33. The base 31 comprises a bottom plate 34 and two upright supports 35. The two upright supports 35 are located at a top side of the bottom plate 34 and spaced from each other at a predetermined distance, each having a pivot connection portion 36 near a top side thereof. The foot pedal 32 is pivotally connected between the two pivot upright supports 35. More specifically, the foot pedal 32 comprises a driven plate 37 and a sector gear 38. The driven plate 37 is pivotally connected between the pivot connection portions 36 of the upright supports 35. More specifically, the driven plate 37 can be extended out of the side opening 26, and biased up and down by an external force. In the present preferred embodiment, the driven plate 37 can be loaded with a return member (for example, return spring) so that when the external force disappears, the driven plate 37 can be automatically returned to the high position. The sector gear 38 is mounted at a bottom side of the driven plate 37, comprising two opposing side face 382, and a tooth rack 384 extended along an arched outer edge of one side face 382. Since the sector gear 38 is located at the bottom side of the driven plate 37, biasing the driven plate 37 up and down by an external force causes the sector gear 38 to bias with the driven plate 37. The composite gear 33 is rotatably mounted on the bottom plate 34 between the two upright supports 35, composing a first gear segment 332 and a second gear segment 334 arranged in a coaxial manner for synchronous rotation. The first gear segment 332 is meshed with the tooth rack 384 of the sector gear 38. In the present preferred embodiment, the axis of the first gear segment 332 and second gear segment 334 extends perpendicular to the bottom plate 34.

The spindle 40 is rotatably mounted on the bottom plate 34, comprising a spindle shaft 42, a third gear segment 44 and a fourth gear segment 46 arranged in a coaxial manner for synchronous rotation. The third gear segment 44 and the fourth gear segment 46 are respectively located at two opposite ends of the spindle shaft 42. Further, the third gear segment 44 is meshed with the second gear segment 334. In the present preferred embodiment, the fourth gear segment 46 is a bevel gear. Further, the axis of the spindle shaft 42, third gear segment 44 and fourth gear segment 46 extends perpendicular to the bottom plate 34.

The cutter module 50 is detachably mounted in the top opening 24 of the housing 20, comprising a cutter holder 52, a cutting shaft 54 and a transmission gear 56. The cutter holder 52 is detachably mounted in the top opening 24 of the housing 20, comprising a recessed grip 53 for gripping by the user's hand. The cutting shaft 54 is rotatably mounted in the cutter holder 52, comprising a plurality of cutter blades 58 for cutting waste documents or CDs. The cutting shaft 54 has one end thereof extended out of the cutter holder 52. The transmission gear 56 is fixedly mounted on the one end of the cutting shaft 54 outside the cutter holder 52 for synchronous rotation with the cutting shaft 54 relative to the cutter holder 52. In the present preferred embodiment, the transmission gear 56 is a bevel gear meshed with the fourth gear segment 46 of the spindle 40.

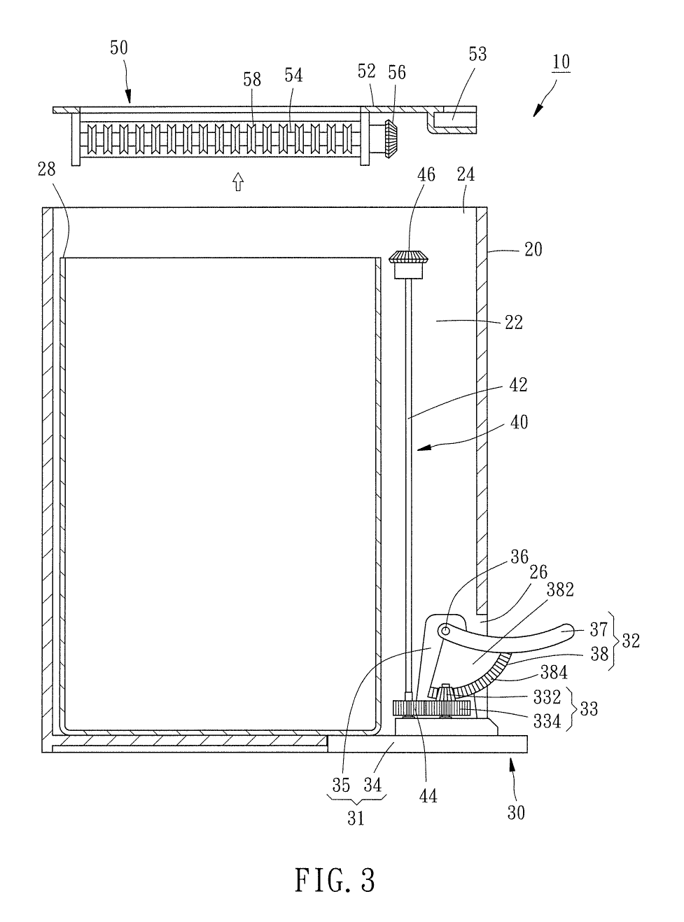

In the present preferred embodiment, the cuffing shaft 54 can be a strip-cut cutting shaft. Alternatively, the cutting shaft 54 can be a cross-cut cutting shaft or any other design of cutting shaft. A strip-cut cutting shaft can cut waste documents or CDs into strips. A cross-cut cutting shaft can cut waste documents or CDs into little pieces. On the other words, the cutter module 50 is a modularized design. The user can selectively use different types of cutter modules 50 with different designs of cutting shafts 54 (such as strip-cut cutting shaft, cross-cut cutting shaft). As illustrated in FIG. 3, the user can remove the cutter module 50 from the top opening 24 of the housing 20 conveniently, and then mount a different cutter module 50 with a different design of cutting shaft 54 subject to different shredding requirements.

In conclusion, when using the foot-operated paper shredder 10 of the present invention, the user can bias the driven plate 37 up and down with the foot to rotate the sector gear 38, the composite gear 33 and the spindle 40, causing the fourth gear segment 46 of the spindle 40 to rotate the transmission gear 56 and the cutting shaft 54, and at this time, the user can put waste documents or CDs into the cutting shaft 54 for cutting into waste strips or little pieces that will then fall to the inside of the accommodation chamber 22 of the housing 20.

Thus, the foot-operated paper shredder 10 of the present invention can be driven to operate by manpower, saving the cost, and it will no longer be limited to specific occasions (such as power outages or no nearby power outlet available), and thus, the foot-operated paper shredder 10 is in line with the current trend of environmental protection and energy conservation. Further, the user can conveniently replace a different design of cutter module 50 according to different shredding requirement.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A foot-operated paper shredder, comprising:
a housing;
a driving mechanism mounted in a bottom of one side of said housing, said driving mechanism comprising a base, a foot pedal mounted on said base and biasable up and down relative to said base, and a composite gear mounted on said base and rotatable by said foot pedal;
a spindle mounted on said base and rotatable by said composite gear; and
a cutter module mounted in a top side of said housing, said cutter module comprising a cutting shaft and a transmission gear fixedly connected to one end of said cutting shaft and drivable by said spindle to rotate said cutting shaft.

2. The foot-operated paper shredder as claimed in claim 1, wherein said cutter module is detachably mounted in the said top side of said housing.

3. The foot-operated paper shredder as claimed in claim 2, wherein said cutting shaft of said cutter module is selectively of a strip-cut cutting shaft or cross-cut cutting shaft.

4. The foot-operated paper shredder as claimed in claim 1, wherein said base comprises a bottom plate and two upright supports located at a top side of said bottom plate and spaced from each other at a predetermined distance, each said upright support comprising a pivot connection portion located near a top side thereof; said foot pedal comprises a driven plate pivotally connected between the said pivot connection portions of said two upright supports, and a sector gear mounted at a bottom side of said driven plate; said composite gear and said spindle are mounted on said bottom plate; said composite gear is meshed with said sector gear.

5. The foot-operated paper shredder as claimed in claim 2, wherein said base comprises a bottom plate and two upright supports located at a top side of said bottom plate and spaced from each other at a predetermined distance, each said upright support comprising a pivot connection portion located near a top side thereof; said foot pedal comprises a driven plate pivotally connected between the said pivot connection portions of said two upright supports, and a sector gear mounted at a bottom side of said driven plate; said composite gear and said spindle are mounted on said bottom plate; said composite gear is meshed with said sector gear.

6. The foot-operated paper shredder as claimed in claim 3, wherein said base comprises a bottom plate and two upright supports located at a top side of said bottom plate and spaced from each other at a predetermined distance, each said upright support comprising a pivot connection portion located near a top side thereof; said foot pedal comprises a driven plate pivotally connected between the said pivot connection portions of said two upright supports, and a sector gear mounted at a bottom side of said driven plate; said composite gear and said spindle are mounted on said bottom plate; said composite gear is meshed with said sector gear.

7. The foot-operated paper shredder as claimed in claim 4, wherein said sector gear comprises two opposing side faces, and a tooth rack extended along an arched outer edge of one said side face; said composite gear comprises a first gear segment and a second gear segment arranged in a coaxial manner for synchronous rotation, said first gear segment being meshed with said tooth rack of said sector gear.

8. The foot-operated paper shredder as claimed in claim 7, wherein said spindle comprises a spindle shaft, a third gear segment and a fourth gear segment arranged in a coaxial manner for synchronous rotation, said third gear segment and said fourth gear segment being respectively mounted at two opposite ends of said spindle shaft, said third gear segment being meshed with said second gear segment, said fourth gear segment being meshed with said transmission gear of said cutter module.

9. The foot-operated paper shredder as claimed in claim 7, wherein said first gear segment is a bevel gear.

10. The foot-operated paper shredder as claimed in claim 8, wherein said fourth gear segment and said transmission gear are bevel gears.

11. The foot-operated paper shredder as claimed in claim 8, wherein said first gear segment, said second gear segment, said third gear segment, said fourth gear segment and said spindle shaft have the respective axes thereof extended perpendicular to said bottom plate.

12. The foot-operated paper shredder as claimed in claim 1, wherein said cutter module further comprises a cutter holder detachably mounted in the said top side of said housing; said cutting shaft is rotatably mounted in said cutter holder, having one end thereof extended out of said cutter holder; said transmission gear is fixedly mounted on the said one end of said cutting shaft outside said cutter holder.

13. The foot-operated paper shredder as claimed in claim 2, wherein said cutter module further comprises a cutter holder detachably mounted in the said top side of said housing; said cutting shaft is rotatably mounted in said cutter holder, having one end thereof extended out of said cutter holder; said transmission gear is fixedly mounted on the said one end of said cutting shaft outside said cutter holder.

14. The foot-operated paper shredder as claimed in claim 3, wherein said cutter module further comprises a cutter holder detachably mounted in the said top side of said housing; said cutting shaft is rotatably mounted in said cutter holder, having one end thereof extended out of said cutter holder; said transmission gear is fixedly mounted on the said one end of said cutting shaft outside said cutter holder.
